(19) United States
(12) Patent Application Publication
(10) Pub. No.: US 2014/0334764 A1
(43) Pub. Date: Nov. 13, 2014

(54) BROADBAND OPTICAL ISOLATOR USING PHASE MODULATORS AND MACH-ZEHNDER INTERFEROMETERS

(71) Applicants: Christophe Galland, LONAY (CH); Thomas Baehr-Jones, Newark, DE (US)

(72) Inventors: Christophe Galland, LONAY (CH); Thomas Baehr-Jones, Newark, DE (US)

(21) Appl. No.: 14/271,863

(22) Filed: May 7, 2014

Related U.S. Application Data
(60) Provisional application No. 61/820,274, filed on May 7, 2013.

(51) Int. Cl. G02F 1/225

(52) U.S. Cl. CPC G02F 1/225; G02F 2001/212
USPC 385/3

(57) ABSTRACT

Optical devices that do not employ magneto-optics materials or non-linear effects to achieve non-reciprocal light propagation. The optical devices are compatible with the fabrication of monolithic photonic integrated circuits such as silicon-on-insulator planar lightwave circuits. In particular the devices use demonstrated passive (beam-splitters, waveguides) and active (phase modulators) components to achieve non-reciprocal light propagation. The devices can be used as non-reciprocal optical modulators or optical isolators when driven by a periodic radio frequency (RF) electric source.

### CROSS-REFERENCE TO RELATED APPLICATIONS

This application claims priority to and the benefit of co-pending U.S. provisional patent application Ser. No. 61/820,274, filed May 7, 2013, which application is incorporated herein by reference in its entirety.

### FIELD OF THE INVENTION

The invention relates to optical devices in general and particularly to an optical isolator.

### BACKGROUND OF THE INVENTION

Optical isolators are nonreciprocal devices that allow the passage of light in one direction and block light in the other direction. They are useful components in optical systems, including telecommunication networks and many opto-electronic devices. For example, they are often placed at the output of laser sources to protect them from back reflection. Existing technologies employed in commercial optical isolators use a material with a large magneto-optic coefficient. The magneto-optic (Faraday) effect causes a propagation-direction-dependent rotation of the light polarization. Various arrangements of optical passive components and polarizers can then be used to build an optical isolator. This approach is used in many commercial fiber optics isolators.

Whereas magneto-optic materials are a practical solution for bulk free-beam and fiber-based isolators, their integration into chip-scale planar photonic circuits is problematic. Magneto-optic materials cannot be fabricated using the techniques compatible with large-scale production of integrated circuits, such as the silicon-on-insulator (SOI) complementary metal-oxide-semiconductor (CMOS) fabrication processes. Obtaining non-reciprocity with the help of magneto-optic materials by constructing a hybrid chip suffers from much increased fabrication complexity. The realization of an integrated optical isolator that does not rely on the magneto-optic effect may be useful for wide-spread development of photonic integrated circuits (PICs), with applications in areas ranging from experimental research in classical and quantum optics, to high-rate telecommunications and data interconnects, to various sensors and lab-on-chip medical devices. In particular, silicon PICs fabricated in processes compatible with the existing CMOS infrastructure hold great promises for cheap, compact and high-speed photonic systems. Most benefits of silicon PICs rely on their entire fabrication in a CMOS-compatible process that ensures scalability, yield and low cost.

Recently, the first electrically driven non-reciprocal device in a silicon PIC was reported, based on the concept of interband photonic transitions developed earlier by Yu and Fan (an idea similar to the one already used for non-reciprocal mode-conversion in optical fibers). See Yu, Z. and Fan, S., Complete optical isolation created by indirect interband photonic transitions, Nature Photon. 3, 91-94 (2009). In this device, a traveling-wave radio-frequency (RF) signal induced a time-varying and spatially non-homogeneous modulation of the refractive index in a silicon waveguide specially engineered to support two transverse electric (TE) modes with opposite symmetries and different propagation constants and wavevectors. While the concept is elegant and no hybrid technology is needed the implementation is prohibitively complicated, and the fabricated device exhibited >70 dB insertion loss.

Others have shown interesting results by employing two “tandem” phase modulators to imprint a non-reciprocal frequency shift. Two limitations of this scheme are its intrinsic narrow-band operation and its modest extinction ratio (10.8 dB reported). Passive resonant structures can be employed to enhance intrinsic silicon non-linearities, but this approach also suffers from narrow optical bandwidth and the performance intrinsically depends on the input light power. Finally, non-reciprocal light modulation can be achieved in traveling-wave modulators, at the cost of very long devices operating at very high-speed, and with only modest extinction ratio.

There is a need for optical isolators that are compatible with conventional semiconductor processing methods.

### SUMMARY OF THE INVENTION

Aspects of the present invention include a new non-reciprocal photonic circuit operating with standard single-mode waveguides in planar lightwave circuits, or in optical fiber systems. Embodiments of the invention may exploit time-dependent index modulation obtained with conventional phase modulators such as the one widely available in integrated photonics platforms. Because it is based on fully balanced interferometers and does not involve resonant structures, the scheme is also intrinsically broadband (>100 nm). Using realistic parameters an extinction ratio superior to 20 dB and insertion loss below −3 dB are estimated for silicon-on-insulator technologies. The invention also does not necessitate the use of traveling-wave modulators to function, nor does it demand very high operation frequency, as was the case in previous publications. This reduces simultaneously the technological complexity, the insertion loss and the achievable footprint.

According to one aspect, the invention features an optical isolator. The optical isolator comprises an input optical coupler; an optical module comprising: a first Mach-Zehnder modulator (MZM) configured to modulate light in each of two waveguide arms; two optical delay lines, one for each of the two waveguide arms, the two optical delay lines optically coupled to a respective output of the first MZM; and a second Mach-Zehnder modulator (MZM) optically coupled to the two optical delay lines and configured to modulate light in each of the two waveguide arms; the input optical coupler optically coupled to the first MZM; an output optical coupler optically coupled to an output of the second MZM; and drive circuitry electrically coupled to each of the two MZMs.

In one embodiment, the drive circuitry is configured to drive each of the MZMs with a periodic drive signal having a predetermined period.

In another embodiment, the optical delay line is configured with a predetermined delay corresponding to a quarter of the predetermined period.

In yet another embodiment, the drive circuitry is configured to drive the MZMs with a drive signal comprising a selected one of a sine wave, a cosine wave, and a square wave having 50% duty cycle.

In still another embodiment, the optical isolator has at least four MZMs.

In a further embodiment, the third and fourth MZMs are present in a second optical module in cascade with the first optical module, the first optical module and the second optical module separated by a delay line having two arms, the output optical coupler optically coupled to an output of the second MZM of the second module in cascade.

In yet a further embodiment, the optical isolator is configured to be compatible with CMOS processing.

In an additional embodiment, the drive circuitry is configured to operate the MZMs so as to modulate light in each of two waveguide arms in a push-pull relationship.

In one more embodiment, an insertion loss is less than −5 dB.

In still a further embodiment, an extinction ratio is greater than −14 dB.

In one embodiment, an optical path difference between a first and a second of the two optical delay lines in the two waveguide arms is adjustable.

Exemplary building blocks of the invention may include Mach-Zehnder modulators (MZMs), which are implemented by placing a phase modulator in each of the two arms of a balanced Mach-Zehnder interferometer (MZI). Two MZMs separated by two optical delay lines, one for each waveguide arm, to form a single “module”. The two optical delay lines can in a preferred embodiment be a waveguide section, which itself forms an MZI between the two MZMs. The isolator is obtained by cascading two such modules.

In each MZM, the phase modulators are operated in push-pull mode, i.e., the sign of the index modulation in the upper and lower arms are opposite. In one embodiment, the two MZMs are driven by delayed signals from the same RF source, which can reside on an electronic RF circuit wire- or bump-bonded to the photonic chip for low parasitic capacitance and small latency. The RF electronic delay and the optical delay between the two MZMs of a single module are matched and equal to a quarter period of the periodic RF signal.

A single module comprising two MZMs separated by an MZI delay section acts as a non-reciprocal modulator that can be used to isolate a pulsed source of known repetition rate from back reflection, or to encode return-to-zero (RZ) symbols, for example. It achieves complete extinction of counter-propagating light independently of the precise driving signal shape and amplitude, with an extinction ratio limited only by the visibility of the interference in the MZIs, but it periodically attenuates the transmitted light in the passing direction.

It is believed that by cascading two of these devices without intermediate optical delay and driving one of them with the RF signal retarded by an additional quarter period, one can achieve isolation with performances comparable to what is obtainable with bulk fiber-based components, while phase and amplitude of the transmitted signal remain non-modulated. The invention does not rely on mode conversion and operates on single-mode waveguides, as required for the use in the dominant silicon-on-insulator PIC technology. This is believed to be the first practical design for a device that provides on-chip broadband optical non-reciprocity. It is expected that devices that embody the invention will be useful in various integrated photonics applications.

In various embodiments, the drive circuitry is configured to operate respective MZMs of said respective arms in a push-pull relationship.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is an illustration of a single module of the invention functioning as a nonreciprocal modulator, as it can be implemented in a PIC.

FIG. 1B is a schematic illustration of the input and output relations for the nonreciprocal modulator of FIG. 1A.

FIG. 1C is a plot of the calculated optical transmission between the different ports identified in FIG. 1B as a function of time in units of the RF period, for a sinusoidal waveform.

FIG. 1D is a plot of the calculated optical transmission between the different ports identified in FIG. 1B as a function of time in units of the RF period, for a bandwidth-limited square waveform.

FIG. 2A is an illustration of the two-stage full isolator obtained by connecting two modules and driving one of them with a quarter-period RF delay with respect to the other.

FIG. 2B is a plot of the calculated optical transmission between the different ports identified in FIG. 2A, as a function of time in units of the RF period, for a sinusoidal waveform.

FIG. 2C is a plot of the calculated optical transmission between the different ports identified in FIG. 2A, as a function of time in units of the RF period, for a bandwidth-limited square waveform.

FIG. 2D is a plot of the calculated optical phase modulation between the different ports identified in FIG. 2A, as a function of time in units of the RF period, for a sinusoidal waveform.

FIG. 2E is a plot of the calculated optical phase modulation between the different ports identified in FIG. 2A, as a function of time in units of the RF period, for a bandwidth-limited square waveform.

FIG. 3A is a plot of the calculated extinction ratio and insertion loss of the two-stage isolator as a function of the phase modulation amplitude for a sinusoidal waveform. Solid lines are for a single module and dashed lines for the full isolator formed by two cascaded modules.

FIG. 3B is a plot of the calculated extinction ratio and insertion loss of the two-stage isolator as a function of the phase modulation amplitude for a bandwidth-limited square waveform.

FIG. 3C is a plot of the calculated extinction ratio and insertion loss of the two-stage isolator as a function of the optical phase difference in between the two arms of a MZI delay section [modulo 2π] for a sinusoidal waveform.

FIG. 3D is a plot of the calculated extinction ratio and insertion loss of the two-stage isolator as a function of the optical phase difference in between the two arms of a MZI delay section [modulo 2π] for a bandwidth-limited square waveform.

FIG. 4A is a schematic of the design of FIG. 1A.

FIG. 4B is a schematic of an alternative design.

FIG. 4C is a schematic diagram of a configuration of the design to be used as a non-reciprocal modulator.

FIG. 4D is a schematic diagram of another configuration of the design to be used as a non-reciprocal modulator. The two designs are equivalent after reversing the light propagation direction and switching the “through” and “cross” ports.

FIG. 5 is a diagram that illustrates how one can drive 4 phase modulators with a retarded square-wave signal.

FIG. 6A is an illustration of an alternative design of the single module employing a single interferometer but uses two additional quarter-period RF delay lines.

FIG. 6B is a schematic illustration of the input and output relations for the alternative design of FIG. 6A.

### DETAILED DESCRIPTION

We describe a new non-reciprocal photonic circuit operating with standard singlemode waveguides or fibers. The non-reciprocal photonic circuit can be fabricated in processes compatible with the existing complementary metal-oxide-semiconductor (CMOS) infrastructure. The non-reciprocal photonic circuit exploits a time-dependent index modulation obtained with conventional phase modulators such as the one widely available in silicon photonics platforms. Because it is based on fully balanced interferometers and does not involve resonant structures, the non-reciprocal photonic circuit is also intrinsically broadband. Using realistic parameters we calculate an extinction ratio superior to 20 dB and insertion loss below −5 dB.

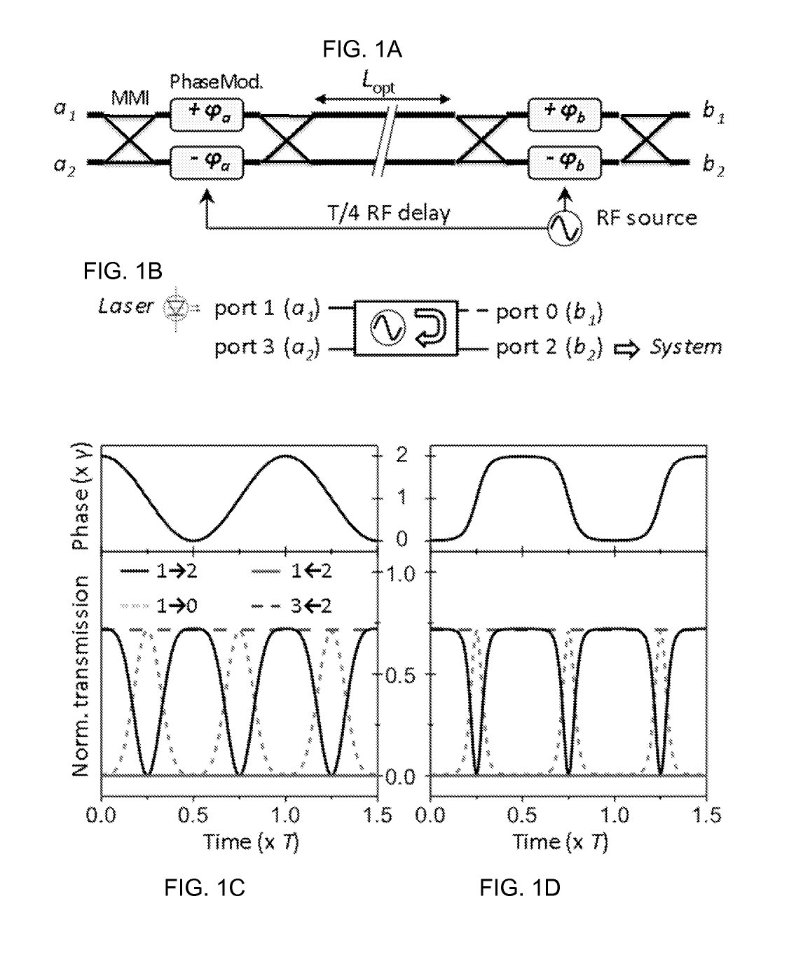

FIG. 1A is an illustration of a single module of the invention functioning as a nonreciprocal modulator, as it can be implemented in a PIC.

FIG. 1B is a schematic illustration of the input and output relations for the nonreciprocal modulator of FIG. 1A.

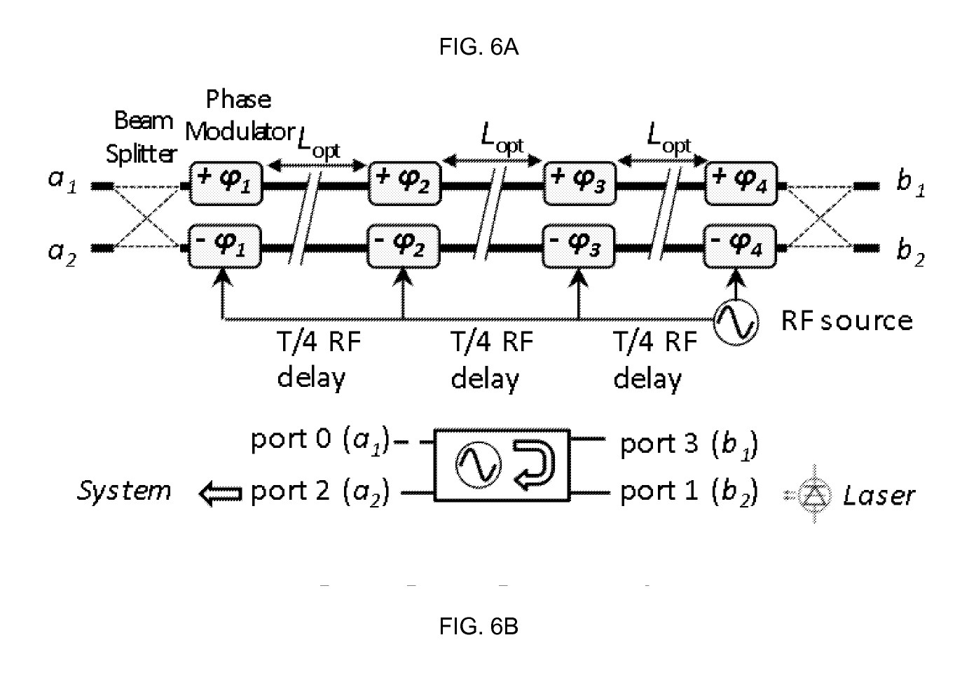

A single module of the invention shown in FIG. 1A includes two Mach-Zehnder modulators (MZMs) driven by the same RF signal and separated by an optical delay line having two arms inducing a quarter-period retardation in the signal driving MZM a (at the left-hand side of FIG. 1A) with respect to MZM b (at the right-hand side of FIG. 1A). An alternative and equivalent design is presented in FIG. 6A and FIG. 6B. Tunable RF delay lines capable of 100 ps delay with little distortion on a 10 Gb/s data stream can readily be implemented in a standard CMOS circuit that could be wire- or flip-chip-bonded to the photonic chip. The RF source produces a periodic voltage proportional to a function F(t):F(t)=F(t+T); with the period T:=1/f; also satisfying F(t±T/2)=−F(t). The function F is normalized to have peak-to-peak amplitude ±1. Examples of such functions (or drive signals) are sine and cosine (sinusoidal) waves, as well as square waves with 50% duty cycle. An MZM is implemented by modulating the optical phase in each arm of the Mach-Zehnder interferometer. For chirp-free operation, the phase modulators are driven in push-pull mode: in the embodiment illustrated in FIG. 1A, the upper arm experiences a phase shift φ(t) while the lower arm is driven symmetrically with a phase shift −φ(t) with respect to a constant offset. In the laboratory time frame of reference, the optical phase modulations in MZM a and MZM b can be written φₐ(t)=γ(1±F(t−T/4)) and φ_{b}(t)=γ(1±F(t)), respectively, with γ the effective phase modulation amplitude (in radians) and +/− for the upper/lower arm. By choosing the waveguide length between the two MZMs to be Lₒₚₜ=T/4 c/n_{g} (n_{g} is the group index and c the speed of light in vacuum) light incoming from the right (ports b₁, b₂) travels in phase with the RF signal and therefore experiences twice the same modulation in MZMs b and a. On the contrary, for light incoming from the left (port a₁, a₂), the modulation functions in MZMs a and b exhibit a π phase shift (i.e. have opposite signs). In this configuration, non-reciprocity is ensured by the presence of two phase-shifted periodic signals. Since high-visibility interference requires the optical path difference between the two arms of the delay line to be adjustable, resistive heaters, for example, may be used to finely tune their relative index. In the following simulations it will be assumed that f=4 GHz, which for a group index of n_{g}=4.2 typical of SOI waveguides leads to Lₒₚₜ=4.46 mm.

An intuitive understanding of the functioning of the invention can be gained through simplified calculations of its idealized transfer matrix. Fully realistic simulations are used next to compute the accurate behavior. Within the coupled-mode formalism, the relationship between complex field amplitudes a₁, a₂ and b₁, b₂ at the input and output of a four-port device, written in vector notation

$$( \begin{matrix}{a}_{1} \\ {a}_{2}\end{matrix} ) ; ( \begin{matrix}{b}_{1} \\ {b}_{2}\end{matrix} ) ,$$

is expressed through a 2×2 matrix. The transfer matrix of an ideal 50/50 beam splitter (for example, a directional coupler or a multimode interferometer, such as the MMI that is shown in FIG. 1A) can be written as:

$$BS = \frac{1}{\sqrt{2}} ( \begin{matrix}1 & i \\ i & 1\end{matrix} )$$

The transfer matrix of an ideal MZM driven in push-pull mode can be written as:

$$M ( ϕ ) = \frac{1}{2} ( \begin{matrix}exp ( iϕ ) - exp ( - iϕ ) & i ( exp ( iϕ ) + exp ( - iϕ ) ) \\ i ( exp ( iϕ ) + exp ( - iϕ ) ) & - exp ( iϕ ) + exp ( - iϕ )\end{matrix} )$$

The transfer matrix of the circuit in FIG. 1A for light propagating from port a to port b (left to right) can be written as:

$${T}^{->} = \frac{1}{4} ( \begin{matrix}1 & i \\ i & 1\end{matrix} ) \times ( \begin{matrix}exp ( {iϕ}_{b} ) & 0 \\ 0 & exp ( - {iϕ}_{b} )\end{matrix} ) \times {( \begin{matrix}1 & i \\ i & 1\end{matrix} )}^{2} \times ( \begin{matrix}exp ( i {{ϕ}^{->}}_{a} ) & 0 \\ 0 & exp ( - i {{ϕ}^{->}}_{a} )\end{matrix} ) \times ( \begin{matrix}1 & i \\ i & 1\end{matrix} )$$

where \vec{φ}ₐ(t)=γF(t−π/Ω)=φ_{b}(t) is the time-dependent optical phase shift experienced in MZM a with reference to the one experienced in MZM b. Similarly, for light propagating from port b to port a (right to left), the transfer matrix of the complete device can be written as:

$$\overleftarrow{T} = \frac{1}{4} ( \begin{matrix}1 & i \\ i & 1\end{matrix} ) \times ( \begin{matrix}exp ( i {\overleftarrow{ϕ}}_{b} ) & 0 \\ 0 & exp ( - i {\overleftarrow{ϕ}}_{b} )\end{matrix} ) \times {( \begin{matrix}1 & i \\ i & 1\end{matrix} )}^{2} \times ( \begin{matrix}exp ( {iϕ}_{a} ) & 0 \\ 0 & exp ( - {iϕ}_{a} )\end{matrix} ) \times ( \begin{matrix}1 & i \\ i & 1\end{matrix} )$$

with the time-dependent phase-shift experienced by the light at MZM a now being [symbol] (t)=γF(t)=φ_{b}(t). Note that the constant phase shift +γ accumulated in each arm have been factored out.

Evaluating these expressions yields:

$$\vec{T} = ( \begin{matrix}- cos ( 2 γ F ( t ) ) & - sin ( 2 γ F ( t ) ) \\ sin ( 2 γ F ( t ) ) & - cos ( 2 γ F ( t ) )\end{matrix} )$$

$$and$$

$$\overleftarrow{T} = ( \begin{matrix}- 1 & 0 \\ 0 & - 1\end{matrix} )$$

As anticipated, the transfer matrix is non-reciprocal. FIG. 1B presents how the system can be conceptualized as an optical circulator by assigning ports 1, 2 and 3 to a₁, b₂ and a₂, respectively (port 0=b₁ can be used for monitoring or can be terminated by a taper to avoid reflection). From the above expression for [symbol] it can be seen that port 1 is perfectly isolated from light incident in port 2, independently of the precise shape and amplitude of the RF signal F(t), as long as the condition Lₒₚₜ=T/4 c/n_{g} is fulfilled.

For the fully realistic simulation, the system of FIG. 1A is decomposed into the following elementary components, and their respective transfer matrices are derived.

The transfer matrix of a beam splitter (BS)—either a directional coupler or a multimode interferometer—having splitting ratio r and insertion loss k (in dB) which can be written as:

$$BS ( r , k ) = \sqrt{{10}^{- k \text{/} 10}} ( \begin{matrix}\sqrt{1 - r} & i \sqrt{r} \\ i \sqrt{r} & \sqrt{1 - r}\end{matrix} )$$

In a Mach-Zehnder modulator (MZM) driven in push-pull mode, the upper arm experiences a phase shift φ(t) while the lower arm is driven symmetrically with a phase shift −φ(t). This is obtained by applying an offset bias and modulating each arm with opposite voltage signs around this offset. Unwanted arm imbalance is accounted for by a phase delay ∂φ in the upper arm relative to the lower arm. Furthermore, dynamic losses caused by free carrier absorption, which typically accompanies phase modulation by plasma dispersion effect, are also taken into account. They are characterized by an excess loss β (in dB) per π phase shift. Under increasing free carrier concentration, the refractive index (and therefore the optical phase delay) decreases, so that, with reference to the intrinsic waveguide delay, the phase modulation term is exp {−i·(−γ{1+F(t)})}=exp {i·γ{1+F(t)}}. The dynamic loss increases under carrier injection and is thus expressed as exp {−α·γ{1+F(t)}}, where

$$α = \frac{βln ( 10 )}{π \cdot 20} .$$

In the opposite arm the factor 1+F(t) is replaced by 1−F(t) to simulate push-pull operation. The transfer matrix for the modulator section in an MZM is then given by:

$$MZ ( γ , α , δϕ , F ( t ) ) = ( \begin{matrix}exp \{ - i \partial ϕ + ( - α + i ) \cdot γ \cdot ( 1 + F ( t ) ) \} & 0 \\ 0 & exp \{ ( - α + i ) \cdot γ \cdot ( 1 - F ( t ) ) \}\end{matrix} )$$

These two general matrices suffice to express all the parts of the invention. In particular, waveguide loss in any section can be introduced with BS(r=0, k>0), while an imbalance between the upper and lower arm of the delay line is simulated by inserting MZ(γ=0, α=0, δφ, F(t)=0). The model can be used to study all relevant optical effects in the linear regime, as well as arbitrary RF signals (including bandwidth limitation, by appropriate choice of the function F(t)), and of course the impact of non-ideal physical implementation such as MZ arm imbalance, asymmetric splitting ratios, and other parameters.

### Dynamic Loss and Free Carrier Modulation

Here the value for the dynamic modulation loss used in the simulations is derived. High-speed (>20 GHz) phase modulation in Si is achieved through the “plasma dispersion” effect, i.e. the change in the complex dielectric function due to a change in free carrier concentration. Soref and Bennett (Soref, R. A. & Bennett, B. R. Electrooptical effects in silicon. IEEE Journal of Quantum Electronics QE-23, 123-129 (1987)) derived the magnitude of this effect, using a combination of previous experimental data:

Δn=−8.8×10⁻²²ΔNₑ−8.5×10⁻¹⁸ΔNₕ^{0.8}

Δα=8.5×10⁻¹⁸ΔNₑ+6.0×10⁻¹⁸ΔNₕ

where Δn is the change in refractive index, Δα is the change in absorption [in cm⁻¹], and ΔNₑ; ΔNₕ the free electron and hole concentrations [in cm⁻³], respectively.

Using these relations we can derive the excess loss [in dB] caused by free carrier absorption for a change of index Δn over a propagation length L, when only free electrons are considered:

βₑ[dB]≈−4.2×10⁴Δn×L[cm]

Similarly for free holes only:

βₕ[dB]≈−5.7×10⁴Δn^{1.25}×L[cm]

Accumulating a π (or 180 degree) optical phase delay corresponds to the condition Δn×L=λ/2 with λ=1.55×10⁻⁴ cm the vacuum wavelength. This leads to the expression for the excess loss intrinsically related to a π phase shift in a device of length L:

β_{π,e}≈−3.25 dB

β_{π,h}≈−0.5×L[cm]^{-0.25} dB

Since both electrons and holes contribute to the plasma dispersion effect in depletion-based PN modulators or injection-based PIN modulators, we use an average value of β_{π}≡β≈−2 dB in the simulations. An interesting question is whether hole-only devices (based on capacitor structures with p-doped waveguides) could be fabricated to lower the dynamic loss in phase modulators, especially in the limit of very long, lightly doped devices.

The simulated behavior of a realistic device is plotted in FIG. 1C and FIG. 1D, for phase modulation amplitude γ=π/4 (π/2 peak-to-peak) and two different waveforms: a pure sine wave and a bandwidth-limited square wave.

FIG. 1C is a plot of the calculated optical transmission between the different ports identified in FIG. 1B as a function of time in units of the RF period, for a sinusoidal waveform.

FIG. 1D is a plot of the calculated optical transmission between the different ports identified in FIG. 1B as a function of time in units of the RF period, for a bandwidth-limited square waveform.

The waveforms are shown in the upper panels of FIG. 1C and FIG. 1D. The transmission coefficients from port 1 to 2, 2 to 1, 1 to 0 and 2 to 3 are plotted in the lower panels. The device is symmetric under the simultaneous permutation 1⇄3 and 0⇄2. The following parameters were used in the simulations: MMI loss=0.1 dB (see for example, Sheng, Z., Wang, Z., Qiu, C., Li, L., Pang, A., Wu, A., Wang, X., Zou, S. and Gan, F. A Compact and Low-Loss MMI Coupler Fabricated With CMOS Technology, Photonics Journal, IEEE 4,2272-2277 (2012), and Halir, R., Molina-Fernandez, I., Ortega-Monux, A., Wanguemert-Perez, J. G., Dan-Xia,X., Cheben, P. and Janz, S. A Design Procedure for High-Performance, RibWaveguide-Based Multimode Interference Couplers in Silicon-on-Insulator, Journal of Lightwave Technology, 26, 2928-2936 (2008); waveguide loss=0.3 dB/cm (see for example, Dong, P., Qian, W., Liao, S., Liang, H., Kung, C.-C., Feng, N.-N., Shafiiha, R., Fong, J., Feng, D., Krishnamoorthy, A. V. & Asghari, M. Low loss shallow-ridge silicon waveguides. Opt. Express 18, 14474-14479 (2010)); total waveguide length=8 mm; dynamic loss=2 dB/π phase shift.

In the calculations we included physically relevant effects such as waveguide loss (−0.3 dB/cm; total waveguide length=8 mm) and beam splitter insertion loss (−0.1 dB), and the dynamic loss intrinsically linked to phase modulation using free-carrier dispersion effect (−2 dB/π phase shift)

Even in the presence of losses, and independent of the signal shape, transmission from port 2 to 1 is exactly zero, demonstrating robust isolation. In contrast, transmission from port 1 to 2 is non-zero, with a maximal value of ˜0.74 (or −1.3 dB) and a time-averaged value of −3.27 dB for a cosine signal. Improved averaged transmission is achieved by driving the modulators with a square-wave. For example, assuming a modulation bandwidth of 5 f (FIG. 1D), time-averaged insertion loss decreases to −2.17 dB.

This first result is by itself remarkable and potentially useful in real systems. For example, the output at port 2 can be directly used as a clock signal, or as an information carrier in return-to-zero encoding schemes. The device can even be used to simultaneously perform the encoding by modulating the amplitude γ. The invention therefore integrates a return-to-zero modulator and a high extinction isolator into a single compact device, making use of only conventional components. The modulation frequency can be chosen arbitrarily, as low as permitted by waveguide propagation losses in the delay line and desired footprint, and as fast as permitted by the modulators and drivers bandwidths. The single module can therefore also be used to isolate pulsed laser sources of known repetition rate.

To obtain a true isolator, consider the device used in reversed direction (or equivalently with an opposite sign of the RF delay). As seen in FIG. 1C and FIG. 1D, there is non-modulated transmission from port 2 to 3, independently of the driving signal parameters, yet there are spikes of transmission from port 3 to 2, preventing complete isolation.

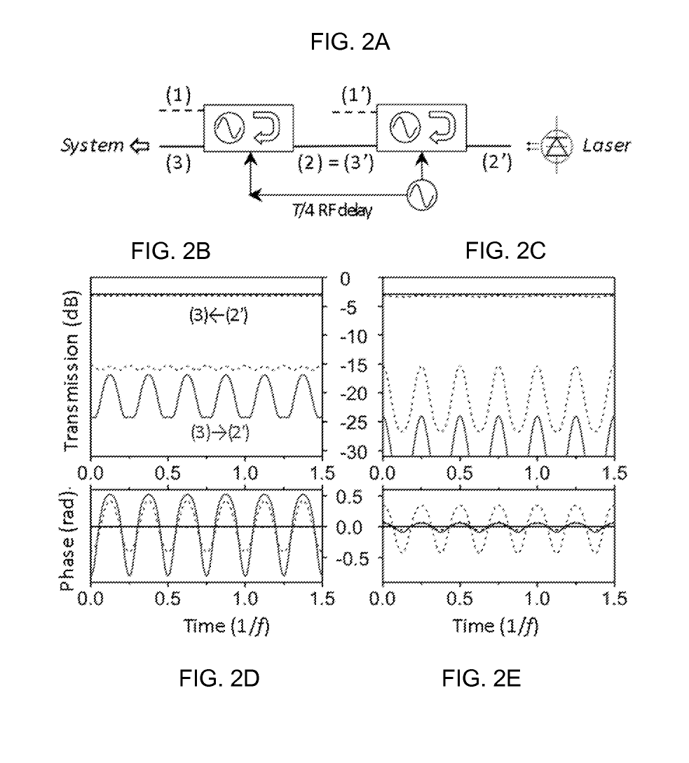

FIG. 2A is an illustration of the two-stage full isolator obtained by connecting two modules and driving one of them with a quarter-period RF delay with respect to the other. FIG. 2A presents the full isolator comprising two cascaded identical modules driven with the same RF source, with a quarter-period RF delay between them. The two modules preferably are positioned immediately next to each other so that negligible optical delay is introduced between them. In this scheme, light passing through the transmission spikes of the first module is always rejected by the second one.

FIG. 2B is a plot of the calculated optical transmission between the different ports identified in FIG. 2A, as a function of time in units of the RF period, for a sinusoidal waveform.

FIG. 2C is a plot of the calculated optical transmission between the different ports identified in FIG. 2A, as a function of time in units of the RF period, for a bandwidth-limited square waveform.

FIG. 2D is a plot of the calculated optical phase modulation between the different ports identified in FIG. 2A, as a function of time in units of the RF period, for a sinusoidal waveform.

FIG. 2E is a plot of the calculated optical phase modulation between the different ports identified in FIG. 2A, as a function of time in units of the RF period, for a bandwidth-limited square waveform.

Solid lines are obtained for perfectly balanced devices, while for dashed lines an arm imbalance of π/10 rad (optical phase) is introduced in each device.

The simulations in FIG. 2B through FIG. 2E demonstrate that this configuration indeed achieves non-modulated transmission of right-to-left propagating light, both in amplitude and phase, with insertion loss of −2.9 dB. Left-to-right propagation is strongly attenuated. Extinction is reduced compared to FIG. 1C and FIG. 1D, but still better than −20 dB in the case of square-wave modulation and perfect arm balancing (−14 dB for cosine modulation). This figure can be further improved by increasing the bandwidth-to-frequency ratio, which is equal to 5 in these simulations. When the optical paths in the arms of each delay line are not perfectly balanced, the performance are slightly degraded, as shown by the dashed lines in FIG. 1C and FIG. 1D for an optical phase mismatch of π/10.

To estimate the impact of relevant parameters and imperfections on the system, two figures of merit are computed: the insertion loss (IL), defined as the time-averaged transmission in the passing direction, and the extinction ratio (ER), equal to the peak transmission value in “blocking” direction divided by the IL.

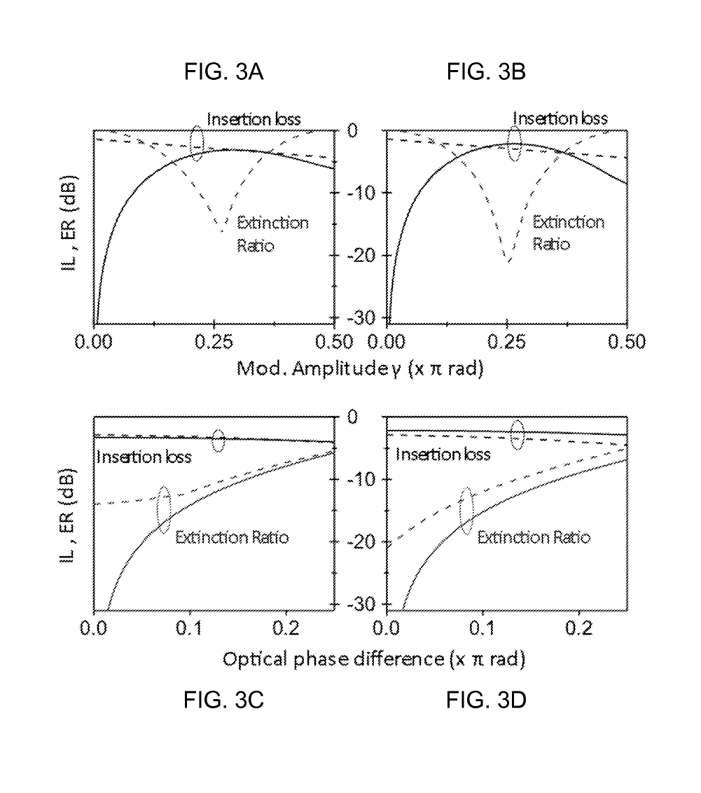

FIG. 3A is a plot of the calculated extinction ratio and insertion loss of the two-stage isolator as a function of the phase modulation amplitude for a sinusoidal waveform. Solid lines are for a single module and dashed lines for the full isolator formed by two cascaded modules.

FIG. 3B is a plot of the calculated extinction ratio and insertion loss of the two-stage isolator as a function of the phase modulation amplitude for a bandwidth-limited square waveform.

As seen in FIG. 3A and FIG. 3B, the optimal modulation amplitude in both cases is close to γ=π/4, which yields the lowest IL for single-pass configuration and the highest ER for cascaded configuration.

FIG. 3C is a plot of the calculated extinction ratio and insertion loss of the two-stage isolator as a function of the optical phase difference in between the two arms of a MZI delay section [modulo 2π] for a sinusoidal waveform.

FIG. 3D is a plot of the calculated extinction ratio and insertion loss of the two-stage isolator as a function of the optical phase difference in between the two arms of a MZI delay section [modulo 2π] for a bandwidth-limited square waveform.

FIG. 3C and FIG. 3D also report the sensitivity of the performances on the relative phase difference accumulated in the two arms of the delay line (modulo 2π). Given the thermo-optic coefficient of silicon dn_{Si}/dT=1.9×10⁻⁴ K⁻¹ around 1.55 μm, the temperature-dependent phase shift (in rad) per unit length of waveguide is calculated to be less than π/4 mm⁻¹ K⁻¹. Controlling the phase difference within π/10 can thus be achieved by tuning the temperature over a 0.4 mm section with 1 K accuracy, well within reach of existing technology. However, some feedback circuit such as those well known in the art will likely be needed to ensure stable operation.

The expected optical bandwidth is now estimated. As the system relies on a series of fully balanced interferometers, it is by design wavelength insensitive. Yet, several second-order effects may limit the actual operating wavelength range. Simple directional couplers usually have limited optical bandwidth, but this can be increased by more advanced designs. Also using multimode interferometers uniform splitting ratio over 94 nm have been demonstrated. Second, due to group velocity dispersion the optical delay between MZM a and MZM b is actually wavelength dependent. Using the dispersion reported in the literature on SOI waveguides and a waveguide length of 4.7 mm, a delay variation of less than 1 ps over more than 100 nm bandwidth around 1550 nm is estimated. This is much smaller than the modulation period (250 ps here) and has therefore negligible impact on performance (the ratio ˜1/250 is independent of the particular modulation frequency). This variation could be further reduced by tailoring the dispersion. The limiting factor may eventually come from the wavelength dependence of the plasma dispersion effect, but this too could be easily compensated by tuning the modulation amplitude γ.

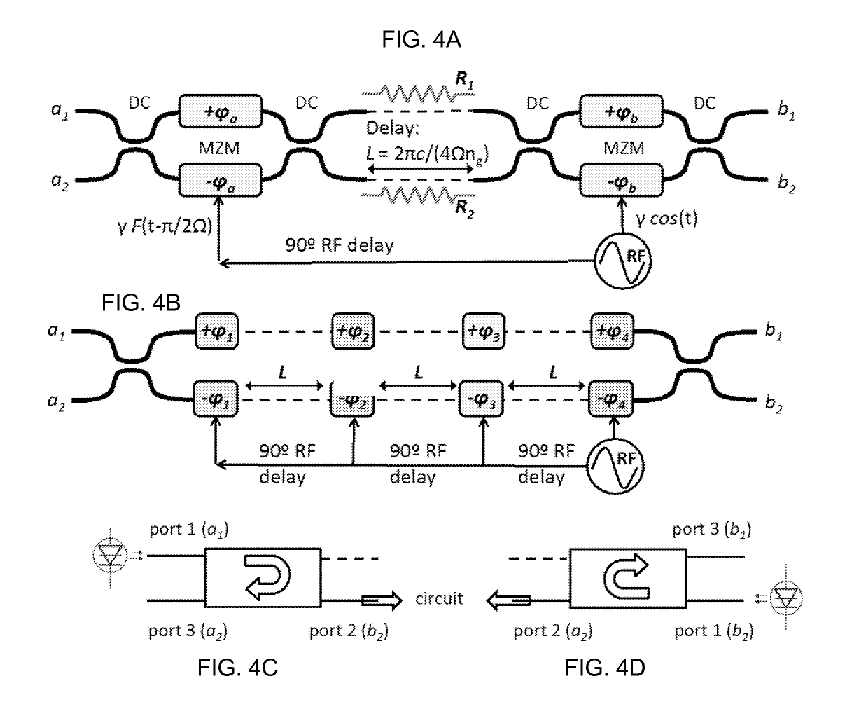

FIG. 4A is a schematic of the design of FIG. 1A.

FIG. 4B is a schematic of an alternative design.

FIG. 4C is a schematic diagram of a configuration of the design to be used as a non-reciprocal modulator.

FIG. 4D is a schematic diagram of another configuration of the design to be used as a non-reciprocal modulator. The two designs are equivalent after reversing the light propagation direction and switching the “through” and “cross” ports.

### Alternative Equivalent Design

An alternative and equivalent design for the single-stage module is illustrated in FIG. 6A.

Here, a single MZI is built with four phase modulators in each arm, pair-wise driven in push-pull mode by the signal F(t). Again, the electric signal is delayed from right to left by a quarter-period between each successive pair of modulators, and an optical path length Lₒₚₜ=T/4 c/n_{g} is introduced to ensure that light launched from the right keeps a fixed relationship with the phase of the electric drive, thus experiencing a total optical phase modulation [symbol] (t)=4γ(1±F(t)). Light propagating from left to right sees a π retardation in the electric signal between each successive modulator, thus accumulating a zero net phase shift relative to the other arm: Δ\vec{φ}(t)=2γ(F(t)+F(t−π/Ω))=0. The transfer matrices for this configuration are therefore:

$${S}^{->} = i ( \begin{matrix}sin ( 4 γ F ( t ) ) & cos ( 4 γ F ( t ) ) \\ cos ( 4 γ F ( t ) ) & - sin ( 4 γ F ( t ) )\end{matrix} )$$

$$and$$

$$\overleftarrow{S} = i ( \begin{matrix}0 & 1 \\ 1 & 0\end{matrix} )$$

We repeat the transfer matrices obtained for the design shown in FIG. 1A:

$${T}^{->} = ( \begin{matrix}- cos ( 2 γ F ( t ) ) & - sin ( 2 γ F ( t ) ) \\ sin ( 2 γ F ( t ) ) & - cos ( 2 γ F ( t ) )\end{matrix} )$$

$$and$$

$$\overleftarrow{T} = ( \begin{matrix}- 1 & 0 \\ 0 & - 1\end{matrix} )$$

As far as the optical field intensity is concerned, the two designs perform the exact same function, after swapping both the roles of the “cross” and “through” ports and the propagation direction, as shown in FIG. 6B. FIG. 6B is a schematic illustration of the input and output relations for the alternative design of FIG. 6A.

The two designs also have the same modulation efficiency and phase shift requirement, since the factor multiplying γ scales with the number of phase modulators in each scheme. While the first design requires two additional beam splitters, it features three-times shorter optical and RF delay lines, yielding lower optical losses, electrical signal attenuation and electronics complexity. Simulations made with this alternative design yielded similar results.

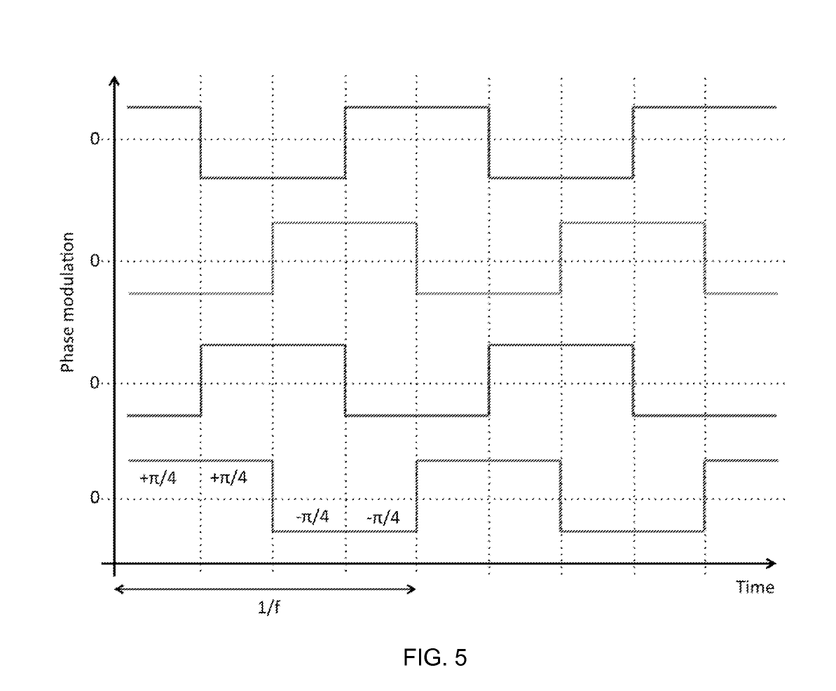

In order to give an intuitive understanding of how the second device functions, consider an ideal square-wave signal (no bandwidth limitation) and split each period into 4 equal intervals Δtᵢ, where i is an integer from 1 to 4 (see FIG. 5). FIG. 5 is a diagram that illustrates how one can drive 4 phase modulators with a retarded square-wave signal.

Any time interval can be labeled with the convention Δtᵢ₊₄=Δtᵢ, i any integer. Denote the phase shift applied on the upper (resp. lower) arm by modulator number j at time i by the matrix element φᵢⱼ. (resp. −φᵢⱼ). With this notation, light traveling from left to right accumulates a phase shift in the upper/lower arm of \vec{φ}_{+/-}=±Σ_{k=0 . . . 3}φ_{i+k,j+k} (with the convention φ_{i,j+4}=φ_{i,j}). This corresponds to summing over the diagonals of the square matrix φᵢⱼ (i,j=1 . . . 4). For light traveling in the “backward” direction (from right to left here), the accumulated phase shift which can be written as: [symbol] _{+/-}=±Σ_{k=0 . . . 3}φ_{i+k,j-k}, corresponding to a sum over the anti-diagonals. With this insight, it is readily seen that the following matrix:

$${ϕ}_{i , j} = \frac{π}{8} ( \begin{matrix}- & - & + & + \\ - & + & + & - \\ + & + & - & - \\ + & - & - & +\end{matrix} )$$

always leads to a null phase shift in the forward direction, while backward propagating light experiences ±π/2 optical phase shift per arm, corresponding to the condition for destructive interference in cross-arm transmission. Using this matrix approach, it is also easy to see that 4 modulation sections is the minimum number to achieve optical isolation.

Aspects of the present invention relate to broadband optical isolators and methods of providing broadband optical isolation using phase modulators and Mach-Zehnder interferometers. A number of optical phase modulators may be used to achieve optical isolation, enabling the flow of light in one direction, but not the other direction. Exemplary optical isolators and methods may provide better control over the flow of optical radiation on a chip.

An exemplary method for optical isolation may use two or four dual-driven Mach-Zehnder modulators, separated by an optical path with propagation time T_rf/4 where T_rf is a period of RF oscillation, in order to achieve broadband, nonreciprocal optical propagation.

An exemplary optical isolator includes an input optical coupler, two waveguide arms optically coupled to the input optical coupler, an output optical coupler optically coupled to the two waveguide arms and drive circuitry. Each waveguide arm includes at least two Mach-Zehnder modulators (MZMs) and an optical delay line optically coupled therebetween. The drive circuitry is electrically coupled to the MZMs of each of the two waveguide arms. The drive circuitry drives the two waveguide arms with a periodic drive signal having a predetermined period. The optical delay line is configured with a predetermined delay corresponding to a quarter of the predetermined period of the periodic drive signal. In other embodiments, the delay can be any odd multiple of a quarter of the predetermined period of the periodic drive signal. According to another exemplary embodiment, each waveguide arm of the optical isolator may include at least four MZMs.

### Definitions

Unless otherwise explicitly recited herein, any reference to an electronic signal or an electromagnetic signal (or their equivalents) is to be understood as referring to a non-volatile electronic signal or a non-volatile electromagnetic signal.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. An optical isolator, comprising:
an input optical coupler;
an optical module comprising:
a first Mach-Zehnder modulator (MZM) configured to modulate light in each of two waveguide arms;
two optical delay lines, one for each of said two waveguide arms, said two optical delay lines optically coupled to a respective output of said first MZM; and
a second Mach-Zehnder modulator (MZM) optically coupled to said two optical delay lines and configured to modulate light in each of said two waveguide arms;
said input optical coupler optically coupled to said first MZM;
an output optical coupler optically coupled to an output of said second MZM; and
drive circuitry electrically coupled to each of said two MZMs.

2. The optical isolator of claim 1, wherein said drive circuitry is configured to drive each of said MZMs with a periodic drive signal having a predetermined period.

3. The optical isolator of claim 2, wherein said optical delay line is configured with a predetermined delay corresponding to a quarter of said predetermined period.

4. The optical isolator of claim 1, wherein said drive circuitry is configured to drive said MZMs with a drive signal comprising a selected one of a sine wave, a cosine wave, and a square wave having 50% duty cycle.

5. The optical isolator of claim 1, having at least four MZMs.

6. The optical isolator of claim 5, wherein said third and fourth MZMs are present in a second optical module in cascade with said first optical module, said first optical module and said second optical module separated by a delay line having two arms, said output optical coupler optically coupled to an output of the second MZM of the second module in cascade.

7. The optical isolator of claim 1, wherein said optical isolator is configured to be compatible with CMOS processing.

8. The optical isolator of claim 1, wherein said drive circuitry is configured to operate said MZMs so as to modulate light in each of two waveguide arms in a push-pull relationship.

9. The optical isolator of claim 1, wherein an insertion loss is less than −5 dB.

10. The optical isolator of claim 1, wherein an extinction ratio is greater than −14 dB.

11. The optical isolator of claim 1, wherein an optical path difference between a first and a second of said two optical delay lines in said two waveguide arms is adjustable.

12. The optical isolator of claim 10, further comprising a heater configured to adjust said optical path difference between said first and said second of said two optical delay lines in said two waveguide arms.
